(19) United States
(12) Patent Application Publication
(10) Pub. No.: US 2019/0135043 A1
(43) Pub. Date: May 9, 2019

(54) PNEUMATIC TIRE

(71) Applicant: TOYO TIRE & RUBBER CO., LTD., Itami-shi (JP)

(72) Inventor: Toshikazu Yasunaga, Itami-shi (JP)

(73) Assignee: TOYO TIRE & RUBBER CO., LTD., Itami-shi (JP)

(21) Appl. No.: 16/168,204

(22) Filed: Oct. 23, 2018

(30) Foreign Application Priority Data
Nov. 8, 2017 (JP) 2017-215874

(51) Int. Cl. B60C 11/03; B60C 11/16; B60C 11/12

(52) U.S. Cl. CPC B60C 11/0302; B60C 11/1625; B60C 2011/0365; B60C 2011/1213; B60C 2011/1254; B60C 11/1204

(57) ABSTRACT

A pneumatic tire includes a center rib extending in a tire circumferential direction at a center in a tire width direction; a plurality of inclined blocks branching and extending from the center rib to both sides in the tire width direction and defined by a plurality of inclined grooves extending obliquely in the tire circumferential direction toward an outside in the tire width direction; and a plurality of stud pins arranged in at least one of inclined blocks, in which the plurality of inclined grooves are arranged at predetermined formation intervals in the tire circumferential direction so as not to intersect with each other, and a length of each inclined groove in the tire circumferential direction is within twice the formation intervals.

### CROSS-REFERENCE TO RELATED APPLICATIONS

This application claims priority of Japanese Patent Application No.: 2017-215874 filed on Nov. 8 2017, the content of which is incorporated herein by reference.

### BACKGROUND OF THE INVENTION

### Technical Field

The present invention relates to a pneumatic tire.

### Related Art

A pneumatic tire has been known which has a plurality of inclined grooves formed in a tread portion so as to be inclined from the center portion in a tire width direction toward both sides and one side in a tire circumferential direction and extend in a V-shape. In the case of the pneumatic tire disclosed in WO2014/091790, main grooves extending in parallel to a tire circumferential direction are not formed, but the deterioration of the drainage performance on a wet road surface is suppressed by V-shaped inclined grooves.

In addition, although stud pins are arranged in this pneumatic tire, no main groove is formed, so that there is no region in a tire width direction where no land portion is formed over the tire circumferential direction. This makes it easy to arrange the stud pins at arbitrary positions in the tire width direction.

### SUMMARY

On the above-described pneumatic tire, an inclination angle of each inclined groove with respect to the tire circumferential direction is small. In other words, the inclined groove stands at a steep angle so as to face the tire circumferential direction rather than the tire width direction in a front view of the tread portion. Therefore, an inclined block defined between a pair of inclined grooves adjacent in the tire circumferential direction tends to be narrow, and the rigidity of the inclined block tends to decrease.

On the other hand, if it is attempted to secure the width of the inclined block defined between the inclined grooves by increasing the intervals at which inclined grooves are formed in the tire circumferential direction, the number of the inclined grooves to be formed decreases. This leads to deterioration in drainage performance.

An object of the present invention to provide a pneumatic tire having an inclined groove instead of a main groove, capable of securing drainage performance while improving the degree of freedom in arranging stud pins, and further capable of suppressing reduction in the rigidity of inclined block.

The present invention provides a pneumatic tire including a center rib extending in a tire circumferential direction at a center in a tire width direction; a plurality of inclined blocks branching and extending from the center rib to both sides in the tire width direction and defined by a plurality of inclined grooves extending obliquely in one side in the tire circumferential direction toward an outer side in the tire width direction; and a plurality of stud pins arranged in at least one of the inclined blocks, in which the plurality of inclined grooves are arranged at predetermined formation intervals in the tire circumferential direction so as not to intersect with each other, and a length of each inclined groove in the tire circumferential direction is within twice the formation intervals.

According to the present invention, the inclined blocks branch and extend to both sides in the tire width direction without being separated from the center rib by the main groove or the like, so that the stud pins can be arranged at arbitrary positions in the tire width direction, ranging from the center rib to each inclined block.

In addition, the plurality of inclined grooves are configured such that the length of each inclined groove in the tire circumferential direction is twice or less than the formation intervals in the tire circumferential direction, so that the inclination angle with respect to the tire width direction can be made small, and each inclined groove can be easily inclined so as to face the tire width direction rather than the tire circumferential direction in a front view of a tread portion. This prevents each inclined block from becoming narrower, so that it is not necessary to increase the formation interval of the inclined grooves in order to secure the width of each inclined block. Therefore, the number of the inclined grooves to be formed does not decrease, so that it is possible to suppress the decrease in the rigidity of each inclined block while ensuring the drainage performance by the inclined grooves. Furthermore, it is easy to increase the component of each inclined groove in the tire width direction, thereby improving the traction performance.

In this specification, the width of the inclined block refers to a dimension obtained by measuring the inclined block in the direction perpendicular to the extending direction of the inclined block when the tread surface is viewed from the direction perpendicular to the surface.

It is preferable that the pneumatic tire further includes a plurality of longitudinal grooves separating the plurality of inclined blocks in the tire width direction, and each of the longitudinal grooves formed in each of the plurality of inclined blocks is different in position in the tire width direction from another longitudinal groove formed in at least one of other inclined blocks.

According to this configuration, the rigidity of the tread portion in the tire width direction can be reduced by each longitudinal groove, so that the tread portion is easily deformed along the road surface, and the ground contact property is improved. Further, each of the longitudinal grooves formed in each of the plurality of inclined blocks is different in position in the tire width direction from another longitudinal groove formed in at least one of other inclined blocks. As a result, even at a position in the tire width direction at which a longitudinal groove is formed in a given inclined block, a stud pin can be disposed in another inclined block.

It is preferable that each of the inclined grooves includes a first inclined groove having a substantially constant groove width and a second inclined groove having a groove width becoming narrower toward the center rib than the groove width of the first inclined groove, and the first inclined groove and the second inclined groove are alternately arranged in the tire circumferential direction; each of the inclined blocks is divided by each longitudinal groove into a center block located inside in the tire width direction and a shoulder block located outer side in the tire width direction of each longitudinal groove; and a center block group is constituted by a pair of the center blocks located between a pair of the first inclined grooves adjacent in the tire circumferential direction.

According to this configuration, the second inclined groove is configured such that the groove width becomes smaller toward the center rib than the groove width of the first inclined groove, so that the pair of the inclined blocks located on both sides of the second inclined groove can be easily made to act as a group of center block groups. Generally, the width of a block among the inclined blocks tends to become narrow relative to a width-direction block extending in the tire width direction, so that rigidity tends to decrease. However, by making the pair of inclined blocks act as a center block group, it is easy to compensate for reduction in rigidity due to the formation of inclined blocks.

It is also preferable that positions of the longitudinal grooves in the center block group in the tire width direction are set such that a second center block located on a step-out side in a tire rotational direction is longer in the tire width direction than a first center block located on a step-in side.

According to this configuration, the second center block located on the step-out side, which is likely to act on the road surface at the time of braking, is longer in the tire width direction than the first center block located on the step-in side, so that the braking performance is easily improved.

It is also preferable that a first shoulder block located on the outer side in the tire width direction via each longitudinal groove relative to the first center block is located between a pair of the second center blocks of the pair of the center block groups adjacent in the tire circumferential direction.

The first shoulder block located in correspondence with the first center block located on the step-in side is made long in the tire width direction, so that the rigidity in the tire circumferential direction tends to decrease. However, according to this configuration, the first shoulder block is sandwiched between the second center blocks of the center block groups. This suppresses reduction in the rigidity of the first shoulder block.

It is preferable that the first center block is shorter than the first shoulder block in the tire width direction.

It is also preferable that a second shoulder block located on the outer side in the tire width direction via each longitudinal groove relative to the second center block is shorter than the second center block in the tire width direction.

It is preferable that a distal end portion of each first inclined groove is located substantially at a center in the tire width direction of a tread portion.

It is preferable that a main groove extending continuously in parallel to the tire circumferential direction is not formed, and the inclined grooves are formed on both sides of the center rib in the tire width direction in a V shape inclined outward in the tire width direction so as to extend to one side in the tire circumferential direction.

It is preferable that the tire rotational direction is designated to another side opposite to the one side in the tire circumferential direction.

According to the present invention, it is possible to secure drainage performance while improving the degree of freedom in arranging stud pins and to further suppress reduction in the rigidity of inclined block in a pneumatic tire including an inclined groove instead of a main groove.

### BRIEF DESCRIPTION OF THE DRAWINGS

The foregoing and the other features of the present invention will become apparent from the following description and drawings of an illustrative embodiment of the invention in which:

FIG. 1 is a partial development view of a tread portion of a pneumatic tire according to one embodiment of the present invention.

### DETAILED DESCRIPTION OF EMBODIMENTS

An embodiment of the present invention will be described below with reference to the accompanying drawing. It should be noted that the following description is merely exemplary in nature and is not intended to limit the invention, its applicable objects, and its applications.

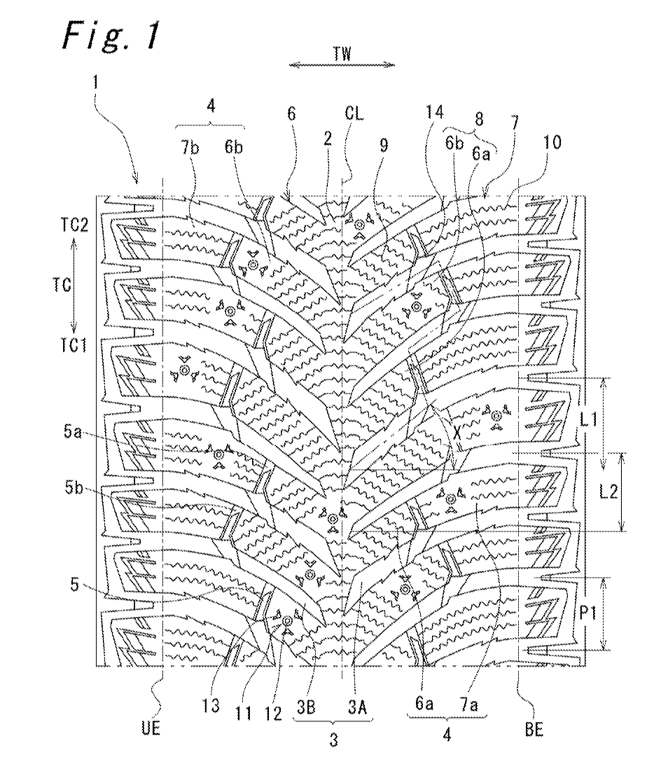

FIG. 1 is a partial development view of a tread portion 1 of a pneumatic tire according to the present embodiment. Referring to FIG. 1, reference symbol TC denotes a tire circumferential direction; and TW, a tire width direction. In the tire circumferential direction TC, a direction going downward in the FIG. 1 is denoted by reference symbol TC1, a direction going upward in the FIG. 1 is denoted by reference symbol TC2. In addition, reference symbol CL denotes the center line (equator line) of the tread portion 1 in the tire width direction. Further, reference symbols UE and BE respectively denote the ground contact ends of both ends of the tread portion 1 in the tire width direction.

A center rib 2 annularly continuous in the tire circumferential direction TC on the center line CL is formed on the tread portion 1. A plurality of inclined grooves 3 are formed on both sides of the center rib 2 in the tire width direction TW so as to extend obliquely in an arcuated shape in the tire circumferential direction TC2 toward the outer side in the tire width direction TW. The inclined block 4 is defined by a pair of the inclined grooves 3 adjacent to each other in the tire circumferential direction. The inclined block 4 branches from the center rib 2 to both sides in the tire width direction TW and obliquely extends in the tire circumferential direction TC2.

In the pneumatic tire according to the present embodiment, the inclined grooves 3 (that is, the inclined blocks 4) are formed in a V shape inclined in the tire circumferential direction TC2 on both sides of the center rib 2 in the tire width direction TW. The tire rotational direction is designated as the tire circumferential direction TC1. Also, in this pneumatic tire, no main groove extending continuously in parallel to the tire circumferential direction is formed.

The inclined groove 3 includes a first inclined groove 3A having a substantially constant groove width and a second inclined groove 3B having a groove width becoming smaller than the first inclined groove 3A toward the center rib 2. The first inclined grooves 3A and the second inclined grooves 3B are alternately arranged in the tire circumferential direction and formed at predetermined formation intervals P1 so as not to intersect with each other.

Portions of both side edges of the first inclined groove 3A are formed in a zigzag shape. The inclined grooves 3 formed on both sides of the center line CL are located with being displaced in the tire circumferential direction TC. The distal end portion of the first inclined groove 3A is substantially located on the center line CL. The second inclined groove 3B extends substantially in parallel with the first inclined groove 3A.

Here, the first inclined grooves 3A and the second inclined grooves 3B are configured such that lengths L1 and L2 in the tire circumferential direction TC are within twice the predetermined formation interval P1 of the inclined grooves 3. As a result, an inclination angle X of the inclined groove 3 with respect to the tire width direction TW becomes small, and the inclined groove can be easily inclined so as to face the tire width direction TW rather than the circumferential direction TC in a front view of the tread portion 1.

The lengths L1 and L2 of the first inclined grooves 3A and the second inclined grooves 3B in the tire circumferential direction TC each mean the length in the tire circumferential direction TC between the groove center at the inner end portion in the tire width direction TW and the groove center at the outer end portion in the tire width direction TW. The formation interval P1 means the length in the tire circumferential direction TC between the groove centers at the outer end portions of the first inclined groove 3A and the second inclined groove 3B in the tire width direction TW.

The predetermined formation interval P1 may be set in the range of, for example, 20 mm or more and 50 mm or less.

In addition, the inclination angle X may be configured to fall within the range of, for example, 20° or more and 60° or less.

A longitudinal groove 5 is formed midway in the inclined block 4 in the tire width direction. The longitudinal groove 5 extends obliquely in the tire circumferential direction TC1 toward the outer side in the tire width direction TW. The longitudinal groove 5 is substantially orthogonal to a pair of the first inclined groove 3A and the second inclined groove 3B located on both sides in the tire circumferential direction TC, and make them communicate with each other in the tire circumferential direction TC. The longitudinal groove 5 separates the inclined block 4 into a center block 6 located on the inner side in the tire width direction TW and a shoulder block 7 located on the outer side in the tire width direction TW.

The longitudinal groove 5 formed in each of the plurality of inclined blocks 4 is different in position in the tire width direction from another longitudinal groove 5 formed in at least one of the other inclined blocks 4. In the present embodiment, the positions of the pair of longitudinal grooves 5 formed in the pair of inclined blocks 4 adjacent in the tire circumferential direction are different in the tire width direction so that the portions projected in the tire circumferential direction do not overlap with each other. Specifically, the pair of longitudinal grooves 5 includes a first longitudinal groove 5a located on the inner side in the tire width direction TW and a second longitudinal groove 5b located in the outer side in the tire width direction TW, and the first longitudinal groove 5a and the second longitudinal groove 5b are alternately formed in the tire circumferential direction TC.

The first longitudinal groove 5a separates the inclined block 4 into a short first center block 6a and a long first shoulder block 7a in the tire width direction TW. Likewise, the second longitudinal groove 5b separates the inclined block 4 into a long second center block 6b and a short second shoulder block 7b in the tire width direction TW.

In this case, the first center block 6a and the second center block 6b are located between a pair of the first inclined grooves 3A adjacent in the tire circumferential direction, and the second inclined groove 3B is formed between the first center block 6a and the second center block 6b. Since the groove width of the second inclined groove 3B is becoming smaller than that of the first inclined groove 3A toward the center rib 2, a pair of the first center block 6a and the second center block 6b located on both sides of the second inclined groove 3B in the tire circumferential direction constitute a center block group 8 (indicated by a two-dot chain line in FIG. 1).

In the center block group 8, the second center block 6b located in the tire circumferential direction TC2 side, that is, on the step-out side (the tire circumferential direction TC2) in the tire rotational direction is longer in the tire width direction than the first center block 6a located on the step-in side (tire circumferential direction TC1).

The inner end portion of the long first shoulder block 7a in the tire width direction TW is located between the outer end portions of a pair of the long second center blocks 6b in the tire width direction TW, which are adjacent in the tire circumferential direction TC. In other words, the inner end portion of the first shoulder block 7a is sandwiched between the outer end portions of a pair of the second center blocks 6b in the tire circumferential direction TC.

Chamfered portions 14 are formed on corner portions of the first center block 6a and the second center block 6b, which are located on the tire circumferential direction TC1 side. The chamfered portion 14 is a flat surface extending crossing the inclined groove 3 and the longitudinal groove 5, and the chamfered portion 14 enhances the rigidity of the first center block 6a and the second center block 6b.

In the center rib 2 and the center block 6 following the center rib 2, first sipes 9 are formed radially around the center rib 2 side. Two or three second sipes 10 are formed in the shoulder block 7 along the longitudinal direction of the shoulder block. The sipes 9 and 10 each have a waveform. One end of the first sipe 9 communicates with the inclined groove 3 and the other end of the first sipe 9 terminates in the center rib 2 or the center block 6. One end of the second sipe 10 communicates with the longitudinal groove 5, and the other end of the second sipe 10 terminates in the shoulder block 7. However, a pin region 11 is formed in each of the blocks 6 and 7 as described later, and the sipes 9 and 10 are not formed in this pin region 11.

A pin region 11 is formed in the center rib 2, the center blocks 6 and the shoulder blocks 7. A pin hole (not shown) is formed in the center portion of each pin region 11, and a stud pin 12 is mounted in the pin hole. Three recesses 13 are formed at equal angular intervals in the periphery of each pin hole.

According to the pneumatic tire having the above configuration, the following effects can be obtained.

(1) The inclined blocks 4 branch and extend in the tire width direction TW without being separated from the center rib 2 by the main groove or the like, so that the stud pins 12 can be arranged at arbitrary positions in the tire width direction TW, ranging from the center rib 2 to the inclined block 4.

(2) The plurality of inclined grooves 3 are configured such that the lengths L1 and L2 in the tire circumferential direction TC each are twice or less than the formation interval P1 in the tire circumferential direction, so that the inclination angle X with respect to the tire width direction TW can be made small, and each inclined groove can be easily inclined so as to face the tire width direction TW rather than the tire circumferential direction TC in a front view of the tread portion 1. This prevents each inclined block 4 from becoming narrower, so that it is not necessary to increase the formation interval P1 of the inclined grooves 4 in order to secure the width of each inclined block. Therefore, the number of the inclined grooves 3 to be formed does not decrease, so that it is possible to suppress the decrease in the rigidity of each inclined block 4 while ensuring the drainage performance by the inclined grooves 3. Furthermore, it is easy to increase the component of the inclined groove 3 in the tire width direction, thereby improving the traction performance.

(3) The rigidity of the tread portion 1 in the tire width direction TW can be reduced by each longitudinal groove 5, so that the tread portion 1 is easily deformed along the road surface, and the ground contact property is improved. Further, the longitudinal groove 5 formed in each of the plurality of inclined blocks 4 is different in position in the tire width direction TW from another longitudinal groove 5 formed in at least one of the other inclined blocks 4. As a result, even at a position in the tire width direction TW at which a longitudinal groove 5 is formed in a given inclined block 4, a stud pin 12 can be disposed in another inclined block 4.

(4) The second inclined groove 3B is configured such that the groove width becomes smaller toward the center rib than the groove width of the first inclined groove 3A, so that the pair of the first center block 6a and the second center block 6b located on both sides of the second inclined groove 3B can be easily made to act as a group of center block groups 8. Generally, the width of a block among the inclined blocks 4 tends to become narrow relative to a width-direction block extending in the tire width direction, so that rigidity tends to decrease. However, by making the first center block 6a and the second center block 6b act as a center block group 8, it is easy to compensate for reduction in rigidity due to the formation of inclined blocks.

(5) The second center block 6b located on the step-out side, which is likely to act on the road surface at the time of braking, is longer in the tire width direction than the first center block 6a located on the step-in side, so that the braking performance is easily improved.

(6) The first shoulder block 7a located in correspondence with the first center block 6a located on the step-in side is made long in the tire width direction, so that the rigidity in the tire circumferential direction TC tends to decrease. However, according to the present embodiment, the first shoulder block 7a is sandwiched between the second center blocks 6b of the center block group 8. This suppresses reduction in the rigidity of the first shoulder block 7a.

What is claimed is:

1. A pneumatic tire comprising:
a center rib extending in a tire circumferential direction at a center in a tire width direction;
a plurality of inclined blocks branching and extending from the center rib to both sides in the tire width direction and defined by a plurality of inclined grooves extending obliquely in one side in the tire circumferential direction toward an outside in the tire width direction; and
a plurality of stud pins arranged in at least one of the inclined blocks,
wherein the plurality of inclined grooves are arranged at predetermined formation intervals in the tire circumferential direction so as not to intersect with each other, and a length of each inclined groove in the tire circumferential direction is within twice the formation intervals.

2. The pneumatic tire according to claim 1, further comprising a plurality of longitudinal grooves separating the plurality of inclined blocks in the tire width direction, wherein
each of the longitudinal grooves formed in each of the plurality of inclined blocks is different in position in the tire width direction from another longitudinal groove formed in at least one of the other inclined blocks.

3. The pneumatic tire according to claim 2, wherein
each of the inclined grooves includes a first inclined groove having a substantially constant groove width and a second inclined groove having a groove width becoming narrower toward the center rib than the groove width of the first inclined groove, and the first inclined groove and the second inclined groove are alternately arranged in the tire circumferential direction,
each of the inclined blocks is divided by each longitudinal groove into a center block located inside in the tire width direction and a shoulder block located outer side in the tire width direction of each longitudinal groove, and
a center block group is constituted by a pair of the center blocks located between a pair of the first inclined grooves adjacent in the tire circumferential direction.

4. The pneumatic tire according to claim 3, wherein positions of the longitudinal grooves in the center block group in the tire width direction are set such that a second center block located on a step-out side in a tire rotational direction is longer in the tire width direction than a first center block located on a step-in side.

5. The pneumatic tire according to claim 4, wherein a first shoulder block located on the outer side in the tire width direction via each longitudinal groove relative to the first center block is located between a pair of the second center blocks of the pair of the center block groups adjacent in the tire circumferential direction.

6. The pneumatic tire according to claim 5, wherein the first center block is shorter than the first shoulder block in the tire width direction.

7. The pneumatic tire according to claim 4, wherein a second shoulder block located on the outer side in the tire width direction via each longitudinal groove relative to the second center block is shorter than the second center block in the tire width direction.

8. The pneumatic tire according to claim 3, wherein a distal end portion of each first inclined groove is located substantially at a center in the tire width direction of a tread portion.

9. The pneumatic tire according to claim 1, wherein a main groove extending continuously in parallel to the tire circumferential direction is not formed, and the inclined grooves are formed on both sides of the center rib in the tire width direction in a V shape inclined outward in the tire width direction so as to extend to one side in the tire circumferential direction.

10. The pneumatic tire according to claim 9, wherein the tire rotational direction is designated to another side opposite to the one side in the tire circumferential direction.
